(19) United States
(12) Patent Application Publication
(10) Pub. No.: US 2020/0019126 A1
(43) Pub. Date: Jan. 16, 2020

(54) TIMER

(71) Applicant: MindsInSync Inc., New York, NY (US)

(72) Inventors: Iain D. SCORGIE, New York, NY (US); David D. BLOCK, Brooklyn, NY (US)

(21) Appl. No.: 16/511,801

(22) Filed: Jul. 15, 2019

Related U.S. Application Data
(60) Provisional application No. 62/697,703, filed on Jul. 13, 2018.

(51) Int. Cl. G04F 1/00

(52) U.S. Cl. CPC G04F 1/005

(57) ABSTRACT

Timers having various functionalities, form factors, and control systems are described. Timers may include single button controls, no-button controls, controls having buttons corresponding to each of several selectable durations. The timers may include task lights, pin lights, and/or lantern type lights. The timers may be powered by removable or permanent batteries, which may be rechargeable by way of, for example, a USB cord, or may be powered by AC or DC adaptor plugs.

### FIELD OF THE INVENTION

The invention relates generally to timers for consumer use, and more particularly to timers having one or more variably lit display elements.

### BRIEF DESCRIPTION OF DRAWINGS

FIG. 1 is an isometric top view of a timer in accordance with an embodiment of the invention;

FIG. 2 is a front elevation view of a timer in accordance with an embodiment of the invention;

FIG. 3 is a side elevation view of a timer in accordance with an embodiment of the invention;

FIGS. 4 and 5 are top plan views of a timer in accordance with an embodiment of the invention;

FIG. 6 is an isometric bottom view of a timer in accordance with an embodiment of the invention;

FIG. 7 is a front elevation view of a timer in accordance with an embodiment of the invention;

FIG. 8 is an isometric front view of a timer in accordance with an embodiment of the invention;

FIGS. 9 and 10 are isometric front views of a timer in accordance with an embodiment of the invention;

FIG. 11 is an isometric front view of a timer in accordance with an embodiment of the invention;

FIG. 12 is an isometric front view of a timer in accordance with an embodiment of the invention;

FIGS. 13A and B are, respectively, a front elevation view and a top plan view of a timer in accordance with an embodiment of the invention;

FIGS. 14a-d are top plan views of a timer in accordance with an embodiment of the invention;

FIGS. 15a-e are isometric front views of a timer in accordance with an embodiment of the invention;

FIG. 16 is an isometric bottom view of a timer in accordance with an embodiment of the invention;

### DETAILED DESCRIPTION

Timers have a variety of uses in the home. They may find application in management of naps, feedings, or activities for babies and children or for cooking or baking, for example. Users of such timers may find it inconvenient or difficult to have two hands free to operate the timer, or to provide significant attention to the process of programming the timer duration. Thus, the inventors have determined that a simplified interface and readout may be useful for home applications.

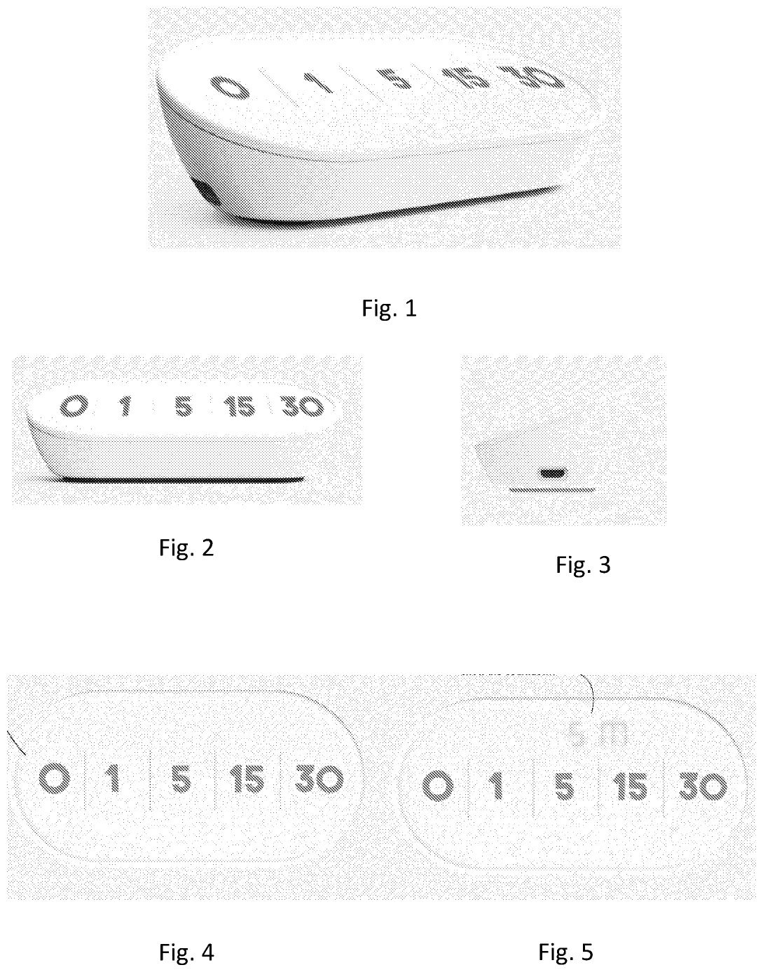

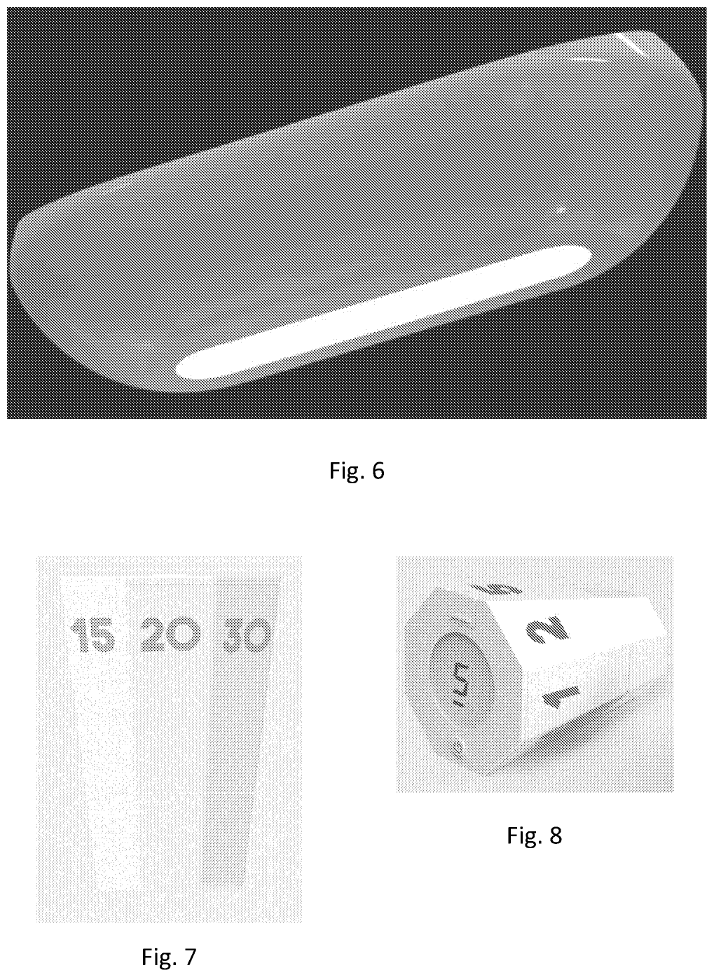

As shown in FIGS. 1-5, an embodiment of the timer may incorporate a highly simplified user interface. In the embodiment shown, one button is included for each of a plurality of time increments. As shown, the increments are 0, 1, 5, 15 & 30. In an embodiment, these time increments are minutes, though in principle, they may likewise be seconds. In response to the button presses, a processor determines the timer set duration. In one example, a first set of presses can be used to select a number of minutes, then after a pause, a number of seconds could be added using the same buttons. In the simplest embodiment, only minutes are included. For activities longer than 30 minutes, multiple presses of the increment buttons can be used to increase the total time. For example, for a one hour, ten minute activity, the user could press the 30 button twice and the 5 button twice.

As shown in FIG. 5, the timer includes a display area that indicates the total selected time. During operation, this same display area will show the time as it is counted down. The display area may include one or more LED or LCD display for showing the time.

It may be useful for the overall shape and size to be selected to fit in a typical user's hand. For example, the length may be on the order of a few inches while the diameter is on the order of about two inches. This provides for ease of use and carry to various parts of the user's house. For example, the length may be between 3 and 6 inches, and more particularly between 4 and 5 inches, while the diameter may be between 1 and 3 inches, or more particularly between 1 and 2 inches. In the context of a non-circular cross section, diameter can be understood to be the longest cross sectional dimension.

The buttons may be of any type, and specifically may include membrane buttons, capacitive touch buttons, or mechanical buttons, as desired.

As the buttons are pressed, the display indicates the total time. In an embodiment, the display is below a top surface of the timer and the light from the display passes through a translucent portion of the top surface. This may be, for example, a plastic surface that is sufficiently thin or transparent to allow the display to show therethrough. The countdown can be automatically initiated. For example, after the final press to select a time, a selected time interval may pass before the countdown begins. This interval may be, for example, one or two seconds.

In an embodiment, the timer allows increased time to be added at any time during the countdown by pressing one of the time select buttons. At the expiration of the timer interval, an audible or visual alarm may be provided. For example, an audible alarm may be set to sound for a time period, for example five seconds. Together with the audible alarm, the display may visually indicate an alarm. In an example, the display may flash 00:00.

During countdown, the timer may be stopped by pressing the 0 button, thereby resetting the timer to a zero time interval. In an embodiment, the alarm may be silenced or the flashing display stopped by pressing the 0 button.

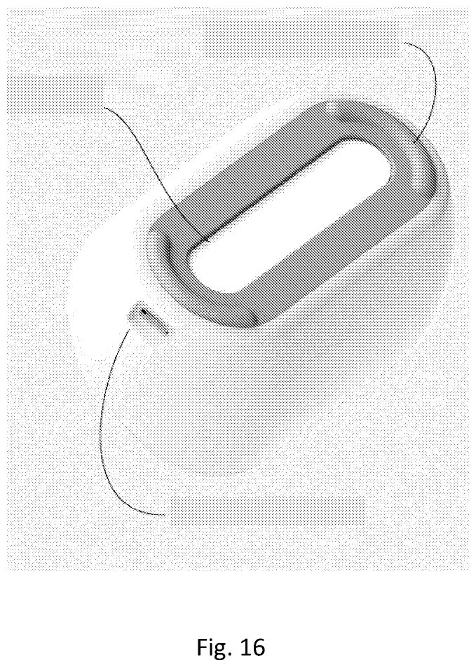

As illustrated in FIG. 16, an embodiment may include a light on the base that can be illuminated by lifting the timer. The light may be activated by detecting lifting motion using an accelerometer, by a pressure switch that is activated on lifting the timer, by a photodiode that detects that the timer is no longer in contact with the surface, or other suitable means. The light may be, for example, a white or blue LED that can provide light for performing childcare activities in a dark room at night. In an embodiment, the light is red, to provide good illumination without harming night vision adaptation of the user.

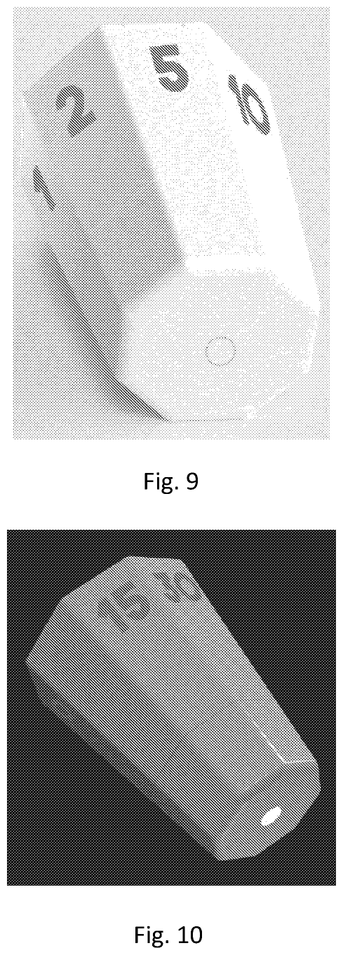

In the embodiment illustrated in FIGS. 7-10, the timer may be used without any buttons at all, or with a single on/off/reset button optionally. In this embodiment, the timer starts when placed on any one of its sides. Any mode of determining orientation of the timer may be used, including but not limited to sensors such as accelerometers and gyroscopes. The sensors may act in conjunction with a processor of the timer, which may be a same processor as the main processor operating the timer, or a separate processor for determining orientation.

In the embodiment, there are eight sides, though a number of sides may be selected in accordance with the number of different time intervals desired to be provided. Each side corresponds to a particular time interval. Optionally, once the timer countdown is begun, the interval may be locked so that accidentally turning the timer does not reset the timer interval.

As seen in FIG. 8, the front of the timer includes a display that shows the time interval selected and that provides the countdown information. As in other embodiments, audio and/or visual alarms may be used to indicate the end of the time interval selected. The alarms may be turned off by use of the on/off/reset button.

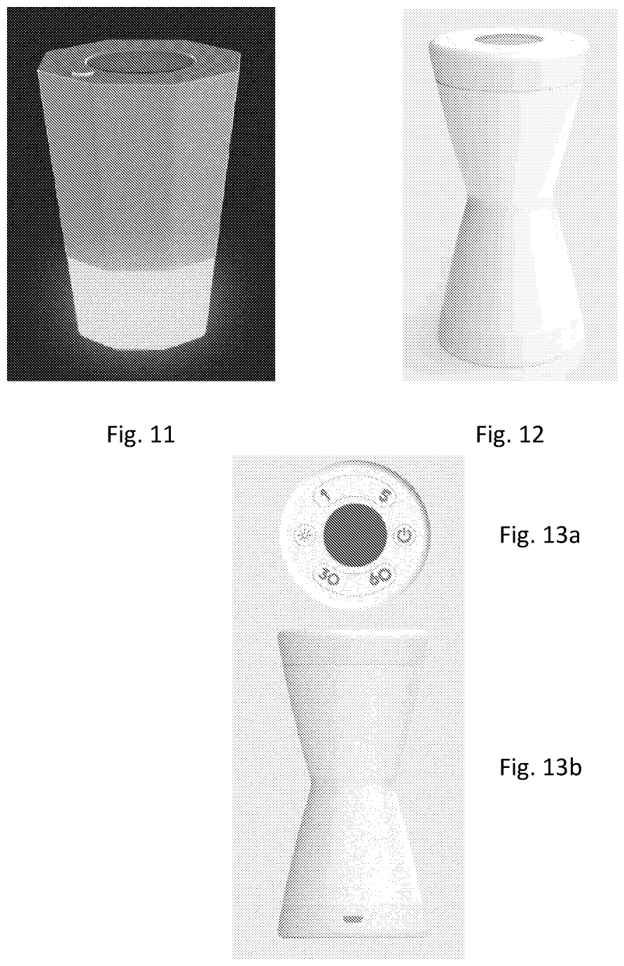

As may be seen in FIG. 10, a light may be provided at the end of the timer that does not include the display. This pin light or spot light may be used to cast a small beam at a particular area. As seen in FIG. 11, the light may be used in a lantern mode. In this mode, a translucent portion of the timer, in the illustrated embodiment corresponding to about one-fourth of the length of the timer, provides a wide area light source that can be used as a lantern.

Selection of the pin light mode vs. the lantern mode can be achieved using the same orientation determining function that is used to select a timer interval. In particular, the device may be configured such that the pin light mode is selected when the timer is held at a particular angle. In one embodiment, the pin light is engaged when the timer is held at or near a 45 degree angle (e.g., between 40-50 degrees) and is turned off when it is at an angle outside that range. To give more functionality, the off may require a greater deviation from the selected angle, for example, it may require a 180 (towards the ceiling) orientation, or a 90 (flat, parallel to the floor) orientation. This would allow a user to scan the floor or a table without accidentally turning off the light.

The lantern mode, in contrast, may be engaged by standing or holding the timer on end as shown in FIG. 11. Lantern mode may be excited by rotating away from the vertical orientation. Alternately, a timer may be included such that lantern mode is shut off after a selected time (for example, 30 seconds or one minute). In an embodiment in which there are no buttons for the user interface, the selected time is not a user-selected time, but rather a predetermined time.

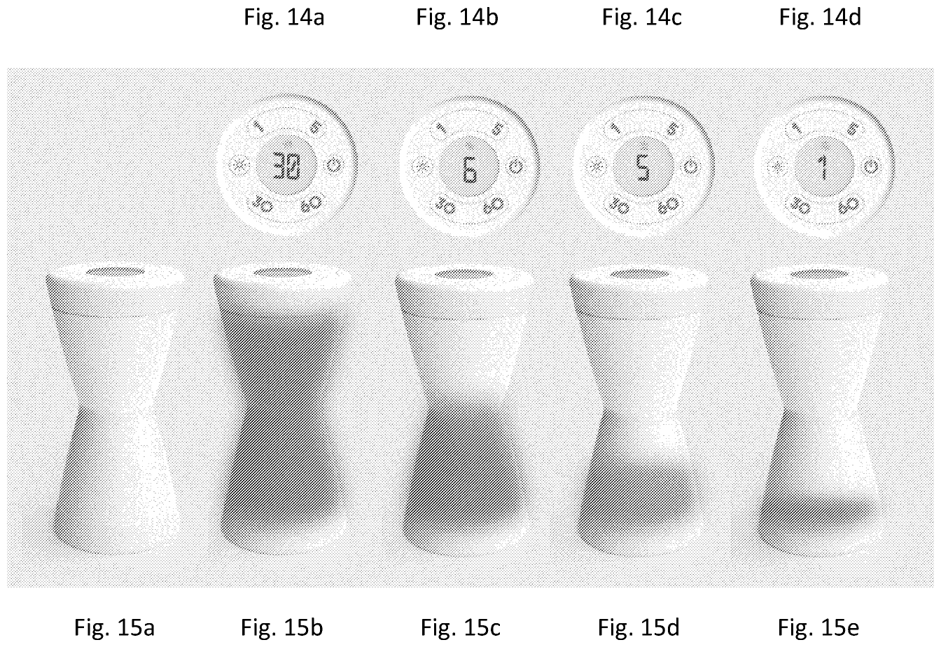

In the embodiment of FIGS. 12-15a-15e, the timer is in an hourglass shape. Like the first embodiment, this embodiment allows for control using a set of buttons on one surface. The timer includes a display, which as before may be LCD, LED or other type of display for showing the remaining time.

As the timer counts down, it provides a visual indicator of remaining time by providing light through a translucent portion of the surface as shown in FIGS. 15a-15e. As the time remaining decreases, a smaller portion of the timer is illuminated. Alternately, an intensity of the light can be decreased as time remaining decreases. In either case, the amount of light generally decreases as the time remaining decreases providing an easy indicator for the user.

As in other embodiments, an audio and/or visual alarm may be triggered as the timer reaches zero. It may be set to automatically end, or may be controllable with an on/off/reset button. Control of the timer is similar to control of the first embodiment.

In an embodiment, the light may be used in a lantern mode similar to that of the preceding embodiment. For this feature, a separate control button may be included for turning the light on and off. As with the other embodiment, the light may be either timed to turn off automatically, or may be controlled by the use of the light button.

In each of the foregoing embodiments, the body or housing of the timer may be made from plastic, for example, ABS plastic. The lights and displays may include LEDs and the internal electronics including power supply for the LED and processor electronics for providing the timer and other functions. In an embodiment, power is provided via a rechargeable battery that may be charged via USB, for example.

In each embodiment, the lights may include color selectivity functionality. That is, for example, by pressing the light button multiple times, different color lights are selected. Colors may be selected for visual appeal, or may be functional such as the night-vision preserving red light described above.

In each embodiment, the alarm may further include a haptic element, such as a vibration.

As shown in FIG. 16, the timer may include a non-slip base, which may be for example a rubber such as EPR or EPDM. Any of the embodiments may include a USB port for charging. The USB may either be open or may include a hinged or slidable cover that hides it when not in use.

Alternately, any of the embodiments may use replaceable rather than rechargeable batteries. Lights may be bulbs rather than LEDs. Rather than USB, other types of charging cords including coaxial DC power adaptors or the like. The timer may incorporate an AC or DC power plug rather than batteries, though typically a more portable battery powered version will be more useful.

As will be appreciated, other variations on the specific appearance and interface may find application consistent with the principles described herein in each of the above-described embodiments.

Although the inventions have been described in detail for the purpose of illustration based on what are currently considered to be the most practical and preferred embodiments, it is to be understood that such detail is solely for that purpose and that the inventions are not limited to the disclosed embodiments, but, on the contrary, are intended to cover modifications and equivalent arrangements that are within the spirit and scope of the described embodiments. For example, it is to be understood that the present invention contemplates that, to the extent possible, one or more features of any embodiment can be combined with one or more features of any other embodiment.

I/We claim:

1. A timer comprising:
a plurality of buttons, each button corresponding to a selected time increment;
a processor, configured to, in response to a plurality of presses of one or more of the plurality of buttons, set a duration for operation of the timer; and
an indicator, configured and arranged to, at an end of the set duration, provide an indication of expiration of the set duration.

2. A timer as in claim 1, further comprising a display configured and arranged to display an amount of time remaining of the set duration.

3. A timer as in claim 1, sized and configured to fit in a user's hand.

4. A timer as in claim 3, wherein a length of the timer is between 3 and 6 inches and a diameter of the timer is between 1 and 3 inches.

5. A timer as in claim 1, wherein the display is below a translucent portion of a top surface of the timer and light from the display is visible through the translucent portion.

6. A timer as in claim 1, wherein after the set duration is selected, the timer automatically begins to count down after a time interval.

7. A timer as in claim 1, further comprising a light, the light operable by lifting the timer from a surface on which the timer is placed.

8. A timer as in claim 7, wherein the lifting is determined by a light detector positioned on a base of the timer.

9. A timer as in claim 7, wherein the lifting is determined by an accelerometer.

10. A timer comprising:
a plurality of sides, each side having an indicium of a duration amount;
a sensor configured and arranged to determine an orientation of the timer;
a processor, configured and arranged to, in response to the determined orientation, set a duration for operation of the timer corresponding to the duration amount indicated on a selected one of the sides; and
an indicator, configured and arranged to, at an end of the set duration, provide an indication of expiration of the set duration.

11. A timer as in claim 10, wherein the processor is further configured to, once the duration is set, retain the set duration irrespective of any later change of orientation of the timer.

12. A timer as in claim 10, further comprising a display configured and arranged to display an amount of time remaining of the set duration.

13. A timer as in claim 10, further comprising a pin light configured to cast a beam of light in a selected direction.

14. A timer as in claim 10, further comprising a lantern configured to cast light in a wide area.

15. A timer as in claim 10, further comprising a light that is selectively configured to operate in a pin light mode or a lantern mode.

16. A timer as in claim 15, wherein the light is configured to select the pin light mode or the lantern mode based on an orientation determined by the sensor.
